(19) United States
(12) Patent Application Publication
(10) Pub. No.: US 2006/0197324 A1
(43) Pub. Date: Sep. 7, 2006

(54) Advanced protection driver area bag

(75) Inventor: Amy L. Klinkenberger, Highland, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/072,250

(22) Filed: Mar. 7, 2005

(51) Int. Cl. B60R 21/16

(52) U.S. Cl. 280/731

(57) ABSTRACT

An air bag for an automobile is mounted on the underside of the steering column. The air bag is positioned in a module integrated within the housing of the steering column on the under surface to add additional protection to the driver from impact with the lower rim of the steering wheel. The column air bag module works in conjunction with a standard driver air bag module. The column air bag deploys in the space between the steering wheel rim and the top of an occupant's thighs.

### BACKGROUND

The present invention is generally related to driver protection devices in automobiles. More specifically, the present invention is related to air bags.

Inflatable air bags have become standard equipment in modern automobiles. Air bag devices, such as driver seat air bag devices and passenger seat air bag devices, are widely used to protect passengers from the impact produced during a vehicle collision. A driver seat air bag device is typically mounted on a boss of a steering wheel and includes a gas injecting inflator, an air bag, and a cover accommodating the air bag in a folded state. During collision of the vehicle, the gas injected from the inflator inflates the air bag. This ruptures the cover, which is made of a soft resin, and forms an opening in the cover. Accordingly, the air bag is inflated through the opening toward the vehicle's driver

According to the 2002 Motor Vehicle Crash Data from FARS and GES, frontal collisions account for 47.9% of all passenger car crashes. Unlike side and rear impacts, virtually all frontal incidents involve the driver. As a result, improvements in driver protection are often statistically more effective in reducing total vehicle occupant exposure to harm than relatively large improvements to side, rear impact and rollover protection.

Typically, air bag devices mounted in the steering wheel protect the drivers head and upper chest during a collision. However, it may be possible to afford increased protection for a driver's abdominal and pelvic region.

### SUMMARY

The present invention relates to a driver protection system having a steering wheel with a rim, a steering column, having a housing, connected to the steering wheel and a column air bag module mounted in the housing of the steering column. When the column air bag deploys it deploys in the space between the steering wheel rim and the top of an occupant thighs.

According to one embodiment of the present invention, a driver area protection device for an automobile has a housing for the column air bag module located on the underside of the steering column.

In yet another embodiment of the present invention a driver area protection device for an automobile further comprises a standard driver air bag mounted in the steering wheel.

In still another embodiment of the present invention, the column air bag module and the standard driver air bag mounted in the steering wheel deploy simultaneously.

It is to be understood that both the foregoing general description and the following detailed description are exemplary and explanatory only and are not restrictive of the invention as claimed.

### BRIEF DESCRIPTION OF THE DRAWINGS

These and other features, aspects, and advantages of the present invention will become apparent from the following description, appended claims and the accompanying exemplary embodiments shown in the drawings, which are briefly described below.

FIG. 1 is an illustration of a side view of a known air bag device after deployment.

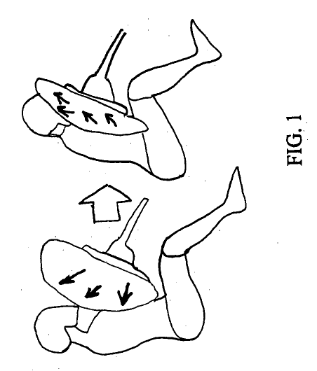

FIGS. 2(a)-2(b) is an illustration of a side view of the advanced protection driver area bag after deployment according to an embodiment of the present invention.

FIG. 3 is an illustration of a front view of the advanced protection driver area bag after deployment according to an embodiment of the present invention.

FIG. 4 is an illustration of a perspective view of the advanced protection driver area bag after deployment according to an embodiment of the present invention.

### DETAILED DESCRIPTION

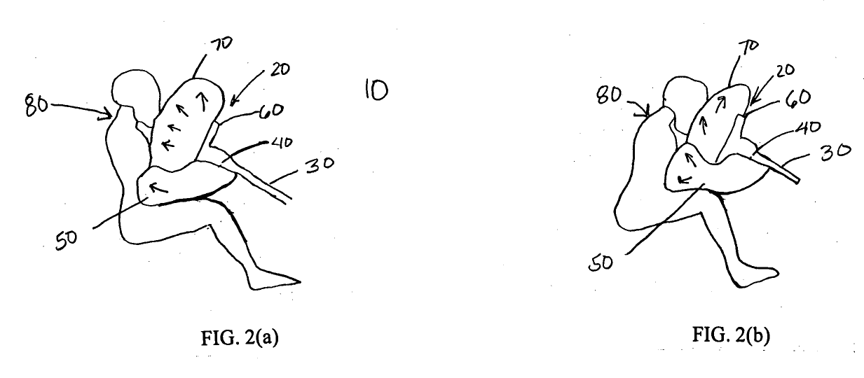

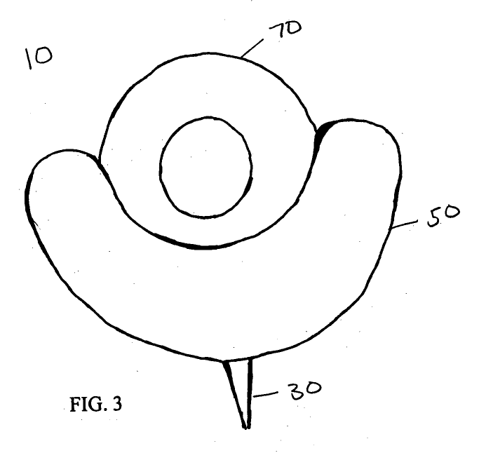

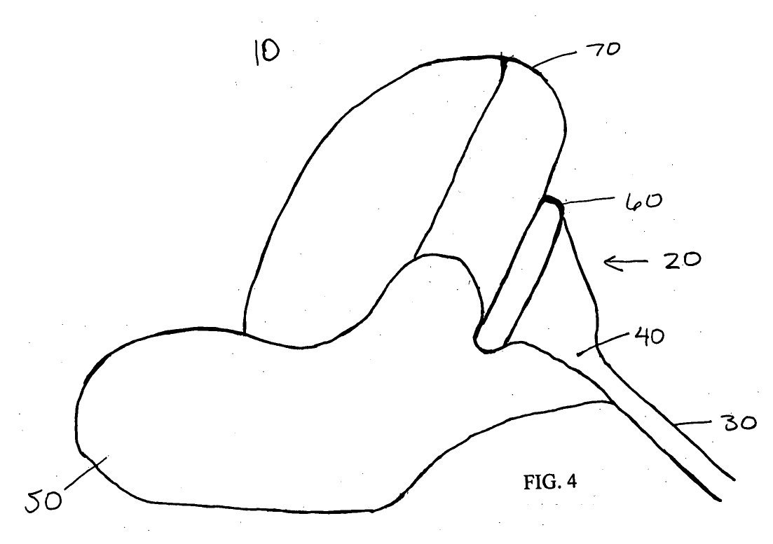

An advanced protection driver area bag 10 according to an embodiment of the present invention is seen in FIGS. 2(a)-4. The driver area protection device 10 includes a steering wheel 20, a steering column 30, having a housing 40, operatively connected to the steering wheel 20 and an air bag 50 mounted in the housing 40. The steering wheel 20 has a rim 60 located at the periphery of the steering wheel 20. The housing 40 is located on the underside of the steering column 30. An appropriately sized air bag 50 is mounted on a fixed surface on the underside of the vehicle steering column 30.

Upon detection of a collision, the column air bag 50 deploys in a space between the steering wheel rim 60 and the top of an occupant's 80 thighs.

The column air bag 50 provides additional protection to the occupant driver 80 by reducing the chance of impact with the lower rim 60 of the steering wheel 20. The air bag may be stored in a module containing an inflator for providing inflation gas. The module may be configured to be integrated into the steering column of the vehicle.

In another embodiment of the present invention, the column air bag 50 works in conjunction with a standard driver air bag 70. The standard driver air bag module 70 is mounted in the steering wheel 20. The column air bag 50 is configured to deploy at the same time as the standard driver air bag module 70. Both modules deploy air bags in the direction of an occupant 80. According to an embodiment of the invention, a single inflator may be used to supply inflation gas to both air bags.

In yet another embodiment of the present invention, the deployment direction will be nearly horizontal so that the column mounted air bag 50 will move along the top of the occupant's thighs, then under and around either side of the lower steering wheel rim to help maintain the occupant's 80 separation from the rim 60 and protect the occupant's 80 abdominal region from direct contact with the rim.

The column mounted bag 50 provides protection for the soft tissue of the abdominal area from contact with the steering wheel rim 60 also serves to limit the forward excursion of the pelvis. During deployment, the column air bag module 50 will follow the natural path along the top of the thighs and contact the bony structures of the pelvis to maintain the pelvis in the properly seated position. By maintaining the proper occupant position the interaction between the knee and the instrument panel are reduced thereby decreasing injury to the knee and hip joint.

It should be understood that various changes to and modifications preferred in the embodiment described herein would be apparent to those skilled in the art. Such changes and modifications can be made without departing from the spirit and scope of the present invention and without demising its attendant advantages. It is therefore intended that such changes and modifications be covered by the appended claims.

What is claimed is:

1. A driver protection system comprising:
a steering wheel having a rim;
a steering column, having a housing, connected to the steering wheel; and
a first air bag stored in the housing of the steering column;
wherein the first air bag is configured to deploy to a position between the steering wheel rim and the top of the driver's thighs.

2. The system of claim 1, wherein the housing is located on the underside of the steering column.

3. The system of claim 1 further comprising a second air bag mounted in the steering wheel.

4. The system of claim 3 wherein the first and second air bags are configured to deploy simultaneously.

5. A system for protecting a driver of a vehicle having a steering wheel with a rim and steering column connected to the steering wheel, comprising
a first air bag mounted in the steering column;
a second airbag mounted in the steering wheel;
wherein the first and second air bags are configured to deploy simultaneously, and
wherein the first airbag is configured to deploy in a substantially horizontal direction so that the first air bag module deploys along the top of the driver's thighs and around the sides of a lower portion of the steering wheel rim to thereby maintain the driver's separation from the rim.
